(19) United States
(12) Patent Application Publication
(10) Pub. No.: US 2003/0014385 A1
(43) Pub. Date: Jan. 16, 2003

(54) Literature distribution methods and apparatus

(76) Inventor: Carl S. Chow, Fremont, CA (US)

Correspondence Address: HEWLETT-PACKARD COMPANY, Intellectual Property Adminstration, P.O. Box 272400, Fort Collins, CO, 80527-2400, US

(21) Appl. No.: 09/905,579

(22) Filed: Jul. 12, 2001

(51) Int. Cl. G06F 7/00

(52) U.S. Cl. 707/1

(57) ABSTRACT

Methods and apparatus for distributing literature. The method includes receiving signals from a client by way of a client interface device and a communication link. The signals are received by a controller which is a component of the apparatus of the instant invention. The apparatus automatically prints literature on sheets of media as selected by the client, and produces a booklet containing the selected literature. Postage for the booklet is automatically calculated by counting the number of sheets of media used in producing the booklet and multiplying this number by the estimated, or approximated, weight of each sheet.

### FIELD OF THE INVENTION

This invention pertains to distribution methods and apparatus, and more specifically, to methods and apparatus for distributing literature.

### BACKGROUND OF THE INVENTION

Often, organizations desire to maintain technical literature for distribution to customers, members of the general public, internal departments, or the like. When I say “technical literature” I mean technical data, in textual, graphical, or pictorial format, including descriptions, criteria, specifications, instructions, procedures, analyses, test results, or the like, which pertain either to a service, or to a product, including devices, compounds, substances, and the like, and which data is configured to be printed on media such as paper media.

Organizations that maintain and distribute technical literature often maintain many different publications of technical literature, wherein each publication is dedicated to a specific product line, a specific product, or a specific service. For example, a manufacturing company may produce and sell many different product lines. Thus, in such a case, the company will typically maintain for distribution many different technical literature publications wherein each publication is in the form of a sales brochure or the like which is dedicated to a specific product line.

Typically, a central warehousing facility is maintained for receiving, storing, and shipping the literature. Often, organizations will order large batches, or runs, of technical literature from commercial printers. Each of the batches can comprise thousands of copies of a given publication. As discussed above, an organization typically maintains many different technical literature publications. Thus, the organization's warehousing facility can contain many thousands, or even millions, of copies of technical literature.

Moving now to FIG. 1, a prior art flow chart 10 is shown. The flow chart 10 depicts a prior art technical literature distribution procedure which comprises the steps S11 through S21. The first step is that of S11 which denotes the beginning of the prior art flow chart 10. Moving to step S13, the organization which maintains and distributes technical literature makes a determination as to the content of each publication. That is, the organization develops the technical data to be contained in each technical literature publication. The technical data to be included in a given publication can depend upon a number of factors including the unique features of the product or service to which the given publication is dedicated. Other factors can include the manner in which the organization wishes to portray the product or service which is presented in the publication.

In accordance with the step S13, the organization can also make determinations as to other characteristics of each publication in addition to the technical data contained therein. For example, in addition to making a determination as to the content of a given publication, the organization can also determine the overall theme of the publication, the general layout of the publication, the quantity of data contained in the publication, the level of detail provided by the publication, the number and type of illustrations and/or photographs contained in the publication, and the like.

Also in accordance with the step S13, the organization orders batches, or runs, of each technical literature publication from a commercial printer. The actual quantity of each publication ordered by the organization is determined by an optimization analysis in which the organization balances, for example, the quantity discounts afforded by economies of scale on the one hand, against storage costs and the like on the other hand.

Another factor used in determining the quantity of each publication ordered is the probably useful life of the publication. The useful life of the publication can be defined as the period of time before the publication becomes obsolete due to changes in the technical data contained therein. In many cases, however, a typical organization would prefer the scenario of ending up with extra, unused publications rather than the alternative scenario which is to end up not having enough publications to distribute to interested customers. Therefore, many organizations order extra copies of each publication to provide a margin of safety.

In accordance with the next step S15 of the flow chart 10, the commercial printer produces the ordered batches of technical literature publications and ships the batches of publications to the organization's warehousing facility. Moving to the step S17, the organization receives the batches of technical literature publications into the warehousing facility and stores the publications therein. In many cases, a typical organization devotes considerable quantities of warehousing space to the storage of technical literature publications. The quantity of warehousing resources required to store the technical literature publications is often compounded by the need to provide continual access to each of the publications so that each publication can be picked and shipped to prospective customers when requested. In accordance with the step S19, the organization receives a request from a customer for several technical literature publications. Moving to the next step of S21, one of the organization's warehousing facility staff members reviews the customer request for technical literature publications. The staff member then locates each of the publications in the warehousing facility, then travels to the locations of the publications and hand picks the requested quantity of each publication.

The staff member then takes the picked publications to a packing point where the publications are hand packed in an envelope along with a cover letter. The envelope is then prepared for mailing, or other means of shipment, by manually weighing of the envelope. The proper amount of postage is then affixed to the envelope in accordance with the weight thereof, and the envelope is transferred to a parcel and letter carrier, such as the United States Postal Service. As is evident, the step S23 denotes the end of the flow chart 10.

Moving now to FIG. 2, a prior art schematic diagram is shown. The schematic diagram depicts a prior art technical literature distribution system 20. The prior art distribution system 20 comprises a headquarters 22 of an organization that maintains and distributes technical literature. In accordance with the prior art distribution system 20, the organization headquarters 22 determines the content of the various technical literature publications that it wishes to distribute.

Once the determination of the technical literature publications content has been made, the organization headquarters 22 then orders batches of each publication from a commercial printer 26. The order can be placed by way of a telephone call, a letter, or the like. The commercial printer 26 then produces the ordered batches of technical literature publications and ships the publications, by way of a freight carrier 28 or the like, to the organization's warehousing facility 30.

The warehousing facility 30 receives the technical literature publications from the freight carrier 28 and stores the publications. A technical literature publication request can be received by the warehousing facility 30 from a first customer 34A. When such a request is received by the warehousing facility 30, a warehousing staff member reviews the request, picks the appropriate publication from locations within the warehousing facility, packs the publications in an envelope 32 and prepares the envelope for mailing to the first customer 34A. The envelope 32 is mailed and is received by the first customer 34A.

Additionally, a request for technical literature publications can be made by a field office 40 of the organization. When such a request is received by the warehousing facility 30, the request is reviewed by a warehousing staff member. The requested publications are picked, packed and mailed to the field office 40. The field office 40 receives the requested technical literature publications and a field representative 42 can then distribute the appropriate publications to a second customer 34B.

As is evident from the discussion above, several problems are associated with the employment of the prior art technical literature publication distribution procedures and system. For example, a great amount of lead time can elapse between the time at which the batches of publications are ordered by the organization headquarters and the time at which the publications are first available for distribution to customers and the like.

In light of the present trend of rapidly changing technology, as well as quickly changing marketing tactics, such a great amount of lead time can cause preprinted technical literature publications to quickly become obsolete. That is, when the applicable technology is improved upon, or otherwise changes, the preprinted technical literature publications are rendered obsolete because the technical data contained therein is no longer valid. This, in turn, can result in a great amount of waste as great quantities of obsolete publications are disposed of.

In addition, a great amount of resources in the form of paper and postage, or shipping costs, is wasted when redundant common data is contained in many single mailings or shipments of publications to various customers. That is, in the cases wherein a customer requests several different publications which each contain at least some common data, the common data can be considered redundant in all but one of the publications. When this phenomenon is multiplied by the number of customers who request and receive publications from the organization, the wasted resources due to redundant technical information can be significant.

As is evident, then, the inclusion of redundant common data necessitated by the use of preprinted publications causes waste of media, such as paper, as well as transportation services, such as postal and delivery services. Furthermore, a great amount of resources is expended in the operation of the warehousing facility. In some cases, the operation of a prior art technical literature publication warehousing facility, along with the warehousing staff, can amount to considerable expenditures.

What is needed then, are technical literature publication distribution methods and apparatus which achieve the benefits to be derived from similar prior art devices, but which avoid the shortcomings and detriments individually associated therewith.

### SUMMARY OF THE INVENTION

The invention includes methods and apparatus for distributing literature to clients on a customized basis. That is, a given client can remotely access an apparatus in accordance with the present invention, wherein the apparatus receives a request from the given client for specific literature. The apparatus includes a database containing literature, wherein the literature selected by the given client is assembled and printed on sheets of media to form a booklet to be mailed, or otherwise sent, to the given client.

In accordance with a first embodiment of the present invention, an apparatus comprises a controller in communication with a booklet-producing device by way of a communication link. The apparatus can also comprise a client interface device which is in signal communication with the controller by way of a respective communication link. A client can access the apparatus by way of the client interface device to initiate the production of a booklet containing literature selected by the client through interaction of the client with the apparatus.

In accordance with a second embodiment of the present invention, a method of distributing literature in the form of a booklet comprises counting the number of sheets of media which are contained in the booklet, estimating the weight of each sheet of media, and multiplying the number of counted sheets of media by the estimated weight of each sheet to calculate the total weight of the media in the booklet. The postage for the booklet can be automatically calculated based on the total weight of the media in the booklet.

In accordance with a third embodiment of the present invention, another method of distributing literature comprises automatically calculating the weight of a booklet which contains selected portions of the literature. The weight of the booklet is calculated by multiplying the number of sheets of media which are used in the booklet by the estimated weight of each sheet of media. The method also includes automatically calculating the postage for the booklet, wherein the postage is calculated based on the weight of the booklet. The method further includes automatically printing the postage on the booklet. The method can include prompting the client for the client's name and address. The client can also be automatically prompted to select literature in which the client is interested. The selected literature is automatically assembled from a database and printed to form a booklet. A cover letter is also automatically generated and printed for inclusion with the literature. The postage for the booklet is automatically calculated based on the number of sheets of media contained in the booklet, and the booklet is mailed to the client.

### DESCRIPTION OF THE DRAWINGS

FIG. 1 is a prior art flow chart which depicts various steps in a prior art method of distributing literature.

FIG. 2 is a schematic diagram of a prior art system for distributing literature, and which can be employed to carry out the steps depicted in the prior art flow chart of FIG. 1.

FIG. 3 is an apparatus for distributing literature in accordance with a first embodiment of the present invention.

FIG. 4 is a flow chart which depicts a number of steps which can be performed to distribute literature in accordance with a second embodiment of the present invention.

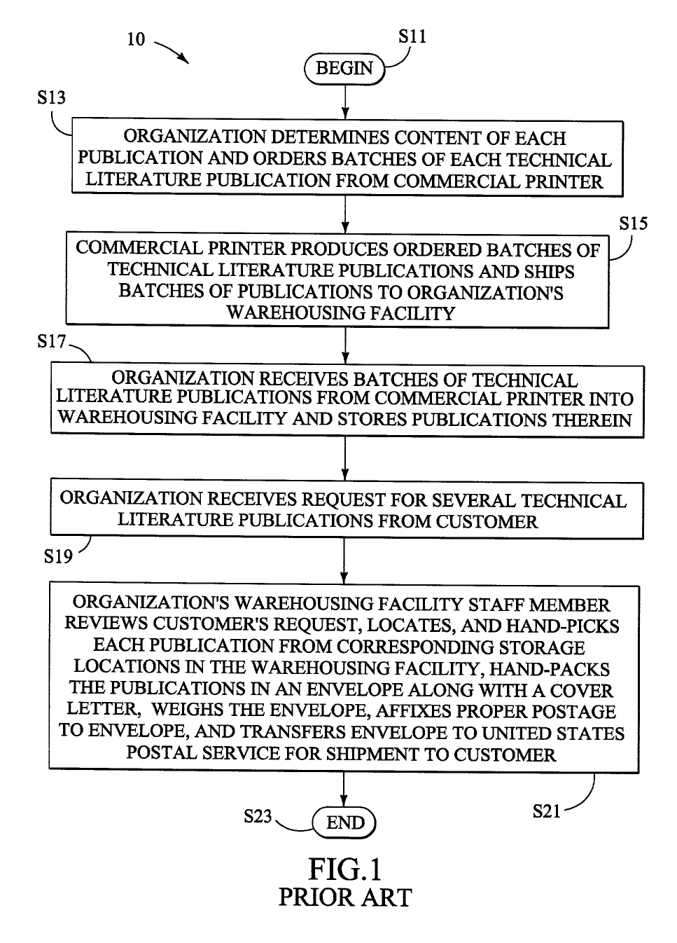

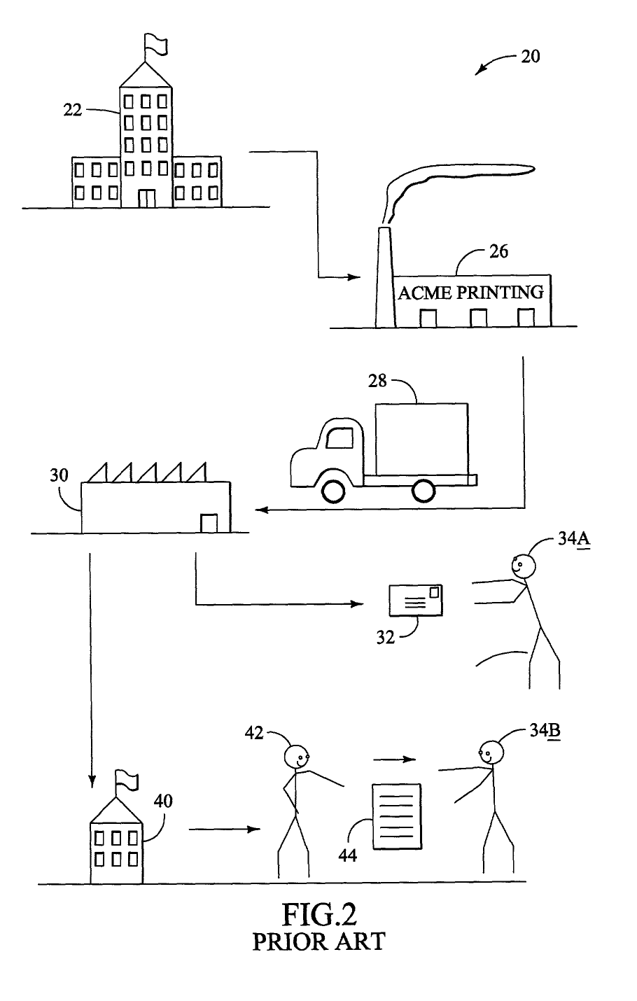

### DETAILED DESCRIPTION OF THE INVENTION

The invention includes methods and apparatus for automatically distributing selected literature as selected by a client who is interested in obtaining the selected literature. An apparatus in accordance with the present invention is configured to automatically produce a booklet containing literature which is selected by the client in response to automatic prompting signals sent to the client by the apparatus. A method in accordance with the present invention includes steps of prompting the client for information which includes the name and address of the client as well as the selected literature in which the client is interested. The method also includes steps for automatically determining the correct postage for the booklet by counting the number of sheets of media which are contained in the booklet.

The expression “booklet,” as used herein, refers to any multi-page document containing information which is desired by an individual. Thus, the expression “booklet” can include pamphlets, magazines, books, flyers, brochures, and any other multi-page document. Further, a “page” can be defined as a separate sheet, or as a folded portion of a folded sheet.

In addition, while the present invention is particularly useful in providing technical literature to a user, the invention should not be considered as limited only to technical literature. For example, a user may desire to obtain a specific selection of printed music. The present invention allows a user to select a variety of different musical pieces, and to have the sheet music for such pieces grouped together in a single booklet. In this manner a user does not need to purchase sheet music for musical selections which the user does not desire to obtain. Yet another example is a user who desires to obtain a selection of images of paintings.

Thus, the term “literature,” as used herein, means data which is in textual, graphical, or pictorial format, and which includes any type of information, including technical literature, which can be distributed to clients by way of the methods and apparatus discussed herein in accordance with the present invention.

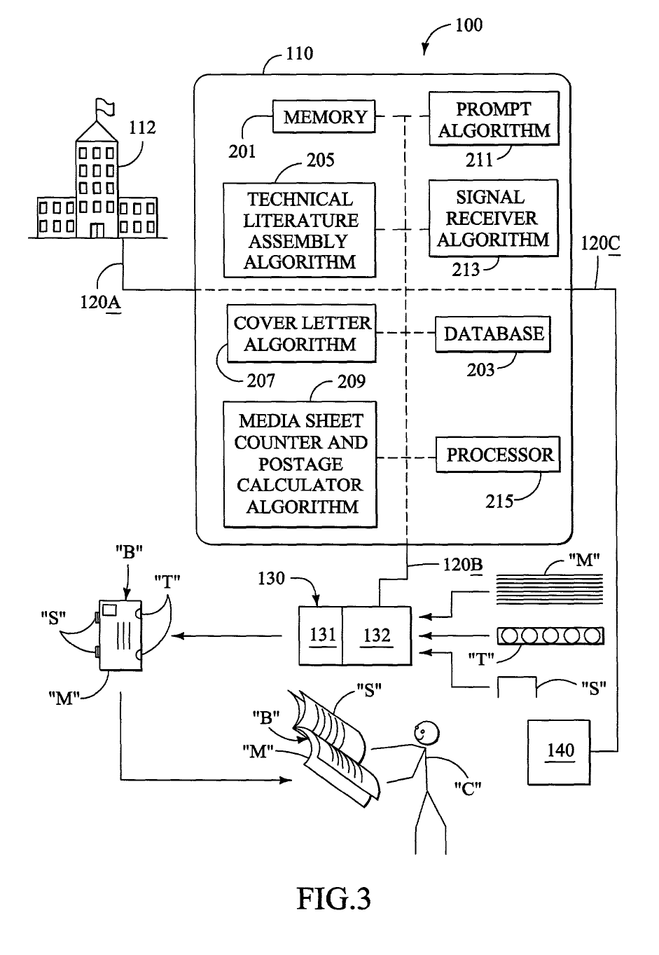

Now moving to FIG. 3, a schematic diagram is shown which depicts a literature distribution apparatus 100. The apparatus 100 can be employed to produce and distribute customized booklets which contain only the literature that is requested by a client. When I say “client” I mean any person who is interested in obtaining literature, and which can include customers, field representatives of the organization which is distributing the literature, members or the general public, and the like.

Although the apparatus is depicted as having separate components such as a controller 110 and a booklet-producing device 130, it should be understood that the components do not necessarily need to be separate components. For example, certain, or all, of the sub-components contained within the controller 110 can be contained within the booklet-producing device 130.

The apparatus 100 comprises a controller 110 which can be in signal communication with the organization 112. When I say that two or more objects are in “signal communication” I mean that signals comprising data can be transmitted between the objects. The apparatus 100 can include one or more communication links 120A, 120B, 120C. For example, a communication link 120A can be employed to connect the controller 110 and the organization 112 in signal communication.

When I say “communication link” I mean any means by which data signals can be transmitted between two or more objects which are in signal communication. Thus, the term “communication link” can include a cable which connects two adjacent electronic devices, as well as a local area network, for example. The term “communication link” can also include portions of a major telecommunication network operated by a commercial local, or long distance, telecommunication carrier, or the internet, for example.

The apparatus 100 also comprises a booklet-producing device 130 which is in signal communication with the controller 110 byway of a communication link 120B. The booklet-producing device 130 can produce a booklet “B” from inputs which in include media “M” such as sheets of paper. The inputs can also include sealing tabs “T” and stitching material “S.” Thus, a booklet “B” can be produced by the booklet-producing device 130, wherein the booklet comprises media “M,” sealing tabs “T,” and stitching material “S.” The booklet “B” also contains literature which is printed in the booklet during production thereof by the booklet-producing device 130.

The booklet-producing device 130 can comprise, for example, an imaging device 132, such as a laser printer or the like, which is configured to receive data in a digital form and print literature there from on sheets of media “M.” One example of such a laser printer is a Hewlett-Packard Model 8550 Color LaserJet printer which is available from the Hewlett-Packard Company of Palo Alto, Calif.

The booklet-producing device 130 can also comprise a finishing device 131 which is configured to fold, and stitch together, sheets of media “M” on which literature is printed by the imaging device 132. One example of a finishing device is a Duplo DBM-80H Booklet Maker which is configured to perform in conjunction with imaging devices, including the Hewlett-Packard Model 8550 Color LaserJet Printer, to produce booklets “B.” The Duplo DBM-80H Booklet Maker is available from the Duplo U.S.A. Corporation of Santa Ana, Calif.

The booklet-producing device 130 can generate images on sheets of media “M” wherein the images are in monochrome (black and white, for example), or in a plurality of tones (four-color printing, for example). The booklet-producing device 130 can comprise additional components as described further below. The booklet “B” and the booklet-producing device 130, as well as the function and operation thereof, will be discussed in greater detail below.

As is evident, the apparatus 100 can comprise a client interface device 140 which is in signal communication with the controller 110 by way of a respective communication link 120C. The client interface device 140 can be any type of device which can be used by the client “C” to interact with the apparatus 100 so as to request a booklet “B” which contains literature specified by the client. The client interface device 140 can include, for example, a telephone, a personal computer, or the like.

The apparatus 100 can comprise a processor 215, which can be, for example, a microprocessor. The processor 215 is configured to control the flow of data and the like, as well as to execute computer-executable steps in the form of programs and the like. The function of the processor 215 with regard to the overall operation of the apparatus 100, will become more apparent in the discussion below.

As is also seen, the apparatus 100 can also comprise a memory 201 which can be a computer-readable memory. The memory 201 can be any type of memory such as a digital memory device, such as a hard drive, a microchip, or a magnetic tape drive, for example. Further, the memory 201 can include read-only memory as well as random access (or “writable”) memory. Although depicted as a single device, the memory 201 can comprise two or more separate memory devices (such as a hard drive and a random access memory on a microchip) which are configured to work in conjunction with one another, as controlled by the processor 215.

The memory 201 is configured to provide data storage capability to facilitate the operation of the apparatus 100. That is, data can be written to the memory 201, and can then be retrieved, or read, from the memory as required by the various other components of the apparatus 100 in furtherance of the purpose for which the apparatus is intended.

The apparatus 100 can also comprise a database 203 which contains literature, such as technical literature, which can be stored in the database in the form of data or the like. The literature contained on the database 203 can be in any form, and is preferably in digital form, wherein the literature can be easily accessed, searched to facilitate retrieval, assembly and formatting of selected portions thereof for printing on media.

The database 203 can be stored on a memory device such as a compact disk (“CD”), a digital video disk (“DVD”), a hard drive, a magnetic tape drive, or a microchip. The literature contained in the database 201 is thus drawn upon during production of the booklet “B” by the booklet-producing device 130. That is, the literature which is used for printing in the booklet “B” is that which is stored in the database 203.

The apparatus 100 can also comprise a literature assembly algorithm 205. The literature assembly algorithm 205 can be employed cause the processor 215, using the other components of the controller 110, to assemble the portions of the literature which are requested by the client “C.” By “assemble” I mean recall from the database 203 and assemble into a file for printing by the booklet-producing device 130.

The literature assembly algorithm 205 can comprise a series of computer-executable steps (a “program”) which can be stored in the memory 201 and executed by the processor 215. That is, the literature assembly algorithm 205 is preferably configured to cause the processor 215 to access the database 203 and to retrieve there from the specific literature which is requested by the client “C.” After accessing the database 203, and retrieving the requested literature therefrom, the literature assembly algorithm 205 causes the processor 215 to organize the requested literature together in a logical sequence and order, and formats the literature for printing in the booklet “B” to be produced by the booklet-producing device 130.

A cover letter algorithm 207 can also be included in the apparatus 100. The cover letter algorithm 207 can comprise a series of computer executable steps (a “program”) which can be stored in the memory 201, and can be executed by the processor 215. The cover letter algorithm 207 is preferably configured to cause the processor 215 to generate a cover letter to be printed in the booklet “B” along with the literature requested by the client “C.” The cover letter algorithm 207 is preferably configured to address the cover letter to the client and to also briefly present an introduction and summary of the literature which is also contained in the booklet “B.”

As is also evident, a media sheet counter and postage calculation algorithm (“counter algorithm”) 209 can also be included in the apparatus 100. The counter algorithm 209 can comprise a series of computer executable steps (a “program”) which can be stored in the memory 201 and executed by the processor 215. The counter algorithm 209 is preferably configured to count the number of sheets of media “M” which are assembled to make up a given booklet “B.”

The counter algorithm 209 can then cause the processor 215 to calculate the total weight of the given booklet “B” by multiplying the number of sheets of media “M” in the given booklet “B” by the estimated, or approximated, weight of each sheet. While an automated scale can be used to weigh each sheet of media “M,” in the preferred embodiment the postage for a given booklet “B” is based on an estimated, or approximated, weight of each sheet of media, since the actual sheet-to-sheet weight variance will typically not affect the final total weight for postage calculation purposes. The postage required to mail the given booklet can then be calculated by the counter algorithm 209 by comparing the total weight of the given booklet “B” to current postal rates.

The counter algorithm 209 can also be configured to estimate the weight of a booklet cover if the booklet “B” is so configured. That is, if the booklet has a cover which is, for example, a heavier sheet of media “M” or a sheet of plastic media “M,” then the counter algorithm 209 can account for the different weight of the cover sheet of media “M” in the calculation of the total weight of the booklet “B.” Additionally, the counter algorithm 209 can be configured to similarly estimate the weight of binding materials “S” which are included in the booklet to hold the sheets of media “M” together.

A prompt algorithm 211 can be included in the apparatus 100 as well. The prompt algorithm 211 can comprise a series of computer executable steps (a “program”) which can be stored in the memory 201 and executed by the processor 215. The prompt algorithm 211 can be employed to cause the processor 215 obtain various information from the client “C” at the time the client requests the booklet “B.”

That is, the prompt algorithm 211 is preferably configured to cause the processor 215 to send an appropriate prompt signal to the client “C” by way of the client interface device 140, and the respective communication link 120C, wherein the prompt signal prompts the client to send a return signal containing data from the client which is required for producing the booklet “B” and the cover letter which, in turn, contain literature requested by the client.

A signal receiver algorithm 213 can be included in the apparatus 100 as well, wherein the signal receiver algorithm 213 is configured to cause the processor 215 to receive signals sent by the client “C” by way of the client interface device 140 and the respective communication link 120C. The receiver algorithm 213 can comprise a series of computer executable steps (a “program”) which can be stored in the memory 201 and executed by the processor 215.

The receiver algorithm 213 can cause the processor 215 to appropriately route incoming signals received from the client “C” to the proper signal destination. For example, when the client “C” sends a signal to the controller 110 which contains the name and address of the client, the receiver algorithm 213 can cause the processor 215 to route the incoming name and address data signal to the memory 201 where the name and address can be stored until needed.

As discussed above, the apparatus 100 comprises a database 203 which contains literature which the organization 112 maintains for dissemination to its various clients “C.” The literature is disseminated by the organization 112 by the distribution of booklets “B” which contain only literature from the database 203 which is specifically requested by the client “C.” The client “C” requests the specific data from the organization 112 by sending the appropriate signals to the controller 110 by way of the respective communication link 120C and in response to various prompt signals sent by the apparatus 100.

The signals sent by the client “C” by way of the client interface device 140 and the respective communication link 120C can be received by the signal receiver algorithm 213 and thereby routed to the appropriate destination within the apparatus 100. The prompt algorithm 211 can then obtain additional information required for the production of a booklet “B” by sending appropriate prompting signals to the client “C” by way of the respective communication link 120C and the client interface device 140.

At least some of the information which is obtained from the client “C” can be stored in the memory 201 until needed for further processing. For example, the name and address of the client “C” can be stored in the memory 201 until needed for production of the respective booklet “B” and/or cover letter. Once the required information has been obtained from the client “C,” the literature assembly algorithm 205 can begin to assemble the requested literature by accessing the database 203.

The literature assembly algorithm 205 can cause the processor 215 to access the memory 201 to obtain various information submitted from the client “C.” In accordance with this information, the assembly algorithm 205 can also cause the processor 215 to assemble the appropriate literature from the database 203 in preparation for production of the respective booklet “B.”

The cover letter algorithm 207 can also begin to cause the processor 215 to generate an appropriate cover letter for inclusion in the booklet “B” which is to be produced for the client “C.” The cover letter algorithm 207 preferably causes the processor 215 to access the memory 201 to obtain appropriate information to be employed in generating the cover letter. For example, the cover letter algorithm 207 can cause the processor 215 to access the memory 201 in order to obtain the name and address of the client “C” previously stored therein so as to include such name and address in the cover letter.

Signals can be sent from the controller 110 to the booklet-producing device 130 by way of the respective communication link 120B, wherein the signals so sent can cause the booklet-producing device to begin producing a booklet “B.” The booklet-producing device 130 can print various data onto sheets of media “M” as directed by the controller 110 in order to produce a booklet “B.” That is, the literature assembly algorithm 205 preferably causes the processor 215 to direct the booklet-producing device 130 to produce a booklet “B” by printing the appropriate literature as selected by the client “C” and as assembled by the assembly algorithm.

Preferably, however, a cover letter is printed for inclusion within the booklet “B” on the beginning pages thereof. The cover letter is preferably printed on media “M” by the booklet-producing device 130 in accordance with the cover letter algorithm 207. As the booklet “B” is produced by the booklet-producing device 130, the booklet-producing device preferably folds the sheets of media “M” in the appropriate places and also stitches the sheets of media together using the stitching materials “S.”

When I say “stitching” I mean any of the known methods of attaching sheets of media to one another to form a multi-sheet booklet, including stapling and gluing, for example. When I say “stitching materials” I mean any of the known materials which are employed for stitching, such as thread, staples, and glue, for example.

As a given booklet “B” is produced by the booklet-producing device 130, the counting algorithm 209 can cause the processor 215 to count the number of sheets of media “M” which are used to complete the given booklet. This can be accomplished by several methods. For example, the booklet-producing device 130 can send a signal to the controller 110 which then gets routed to the counter algorithm 209, wherein the signal is sent for each sheet of media “M” that the booklet-producing device uses to complete the given booklet “B.” The counting algorithm 209 can then use the number of sheets of media “M” used to complete the given booklet “B” to calculate the appropriate postage for the given booklet.

When the processor 215, using the counting algorithm 209, determines the appropriate postage for the given booklet “B,” the counting algorithm can then cause the processor to instruct the booklet-producing device 130 to print the appropriate postage on the given booklet. Such printing of the postage on the booklet by the booklet-producing device 130 can be accomplished by way of a postage meter (not shown), or the like, which can be incorporated into the booklet-producing device and employed in conjunction therewith to meter and print postage for each booklet “B” produced by the booklet-producing device.

The booklet-producing device 130 preferably prints the name and address of the client “C” on the outer surface of the booklet “B” to facilitate delivery thereof to the client by way of a delivery service such as the United States Postal Service, or the like. Also, the booklet-producing device 130 preferably applies at least one sealing tab “T” in the appropriate location on the booklet “B” so as to seal the booklet in a closed position for shipment or mailing thereof. Once the booklet “B” is received by the client “C” the sealing tabs “T” can be cut or otherwise unsealed by the client to allow opening of the booklet for access to the literature contained therein.

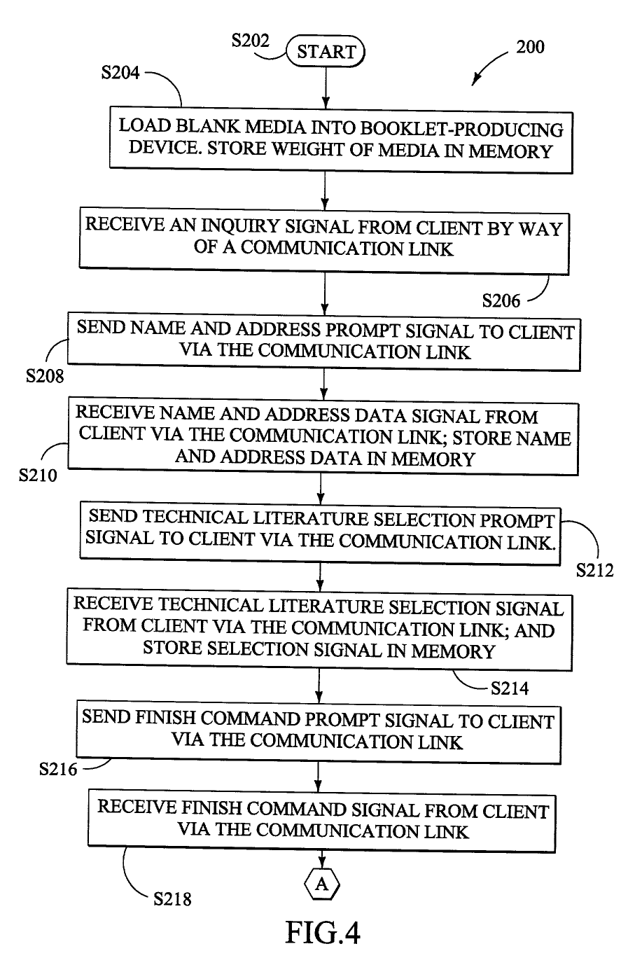

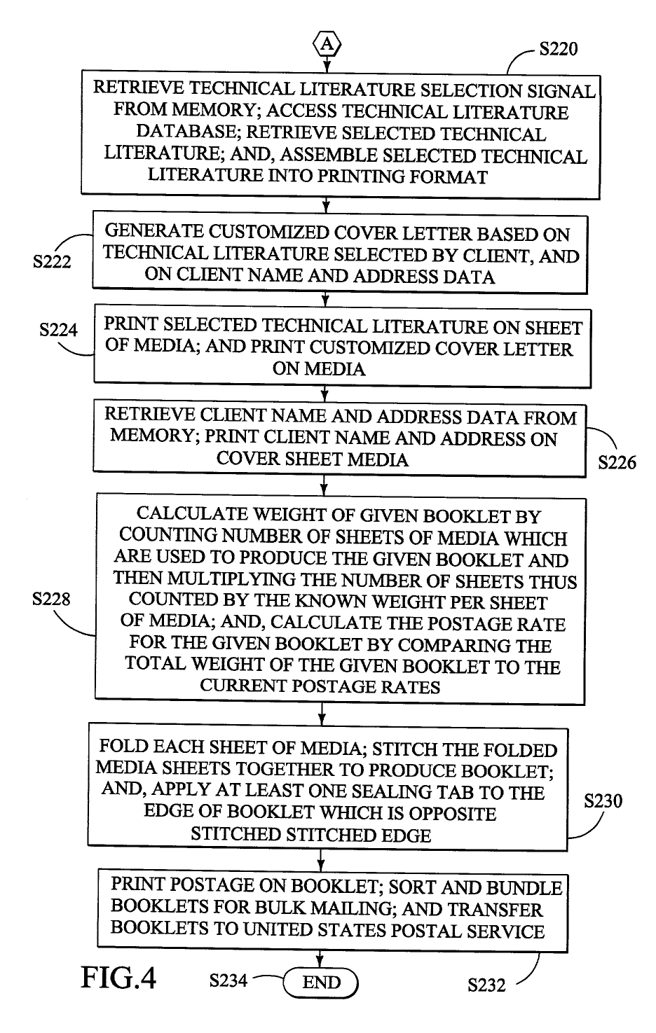

Moving now to FIG. 4, a flow chart 200 is shown which represents a series of steps in the operation of the apparatus 100 which is described above for FIG. 3. The flow chart 200, shown in FIG. 4, will now be described in conjunction with the schematic diagram of the apparatus 100 shown in FIG. 3. As is evident, the beginning of the flow chart 200 is denoted by the step S202. The next step, that of S204, is to load media “M” into the booklet-producing device 130. For example, if the media “M” being used is paper, then a ream of paper media can be loaded into the booklet-producing device 130 in accordance with step S204.

The process of loading the media “M” into the booklet-producing device 130 in accordance with step S204 can be accomplished by manually loading the media into the device. In conjunction with the process of loading the media “M” into the booklet-producing device 130, the weight of the media can be stored in the memory 201. The storage of the weight of the media “M” in the memory 201 is required for the calculation of the weight of the booklet “B” in accordance with the counting algorithm 209 as described above, wherein the weight of a given booklet is used to calculate the required postage for the given booklet.

The storage of the weight of the media “M” can be accomplished manually. For example, in the case wherein the media “M” is paper, the weight of the paper can be manually entered into the memory by first visually reading the weight of the paper from the paper packaging, for example, and then manually keying in the weight by way of a data-entry device (not shown) or the like, such as a manual keypad. That is, when the paper media “M” is loaded into the booklet-producing device, the weight of the paper can be read from the media packaging and then typed, or otherwise entered, into the memory by way of the manual keypad.

For example, if the paper media “M” used is known as twenty-pound paper, then a ream (500 sheets) of such paper generally weighs about five pounds. In such a case, the twenty-pound weight designation of the paper media “M” can be manually read from the labeling of the media “M” and the weight can then be manually entered into the memory 201 by way of the manual keypad. The counting algorithm 209 can be configured to cause the processor 215 to calculate the estimated, or approximated, weight of a single sheet of such media “M” by dividing the weight of a ream of media by the number of sheets of media in a ream of media.

That is, for example, if twenty-pound paper media “M” is used and the twenty-pound designation is entered into the memory 201 to denote twenty-pound paper, then the counting algorithm 209 can be employed to determine the theoretical weight of each sheet of such media by dividing five pounds by five hundred sheets. Thus, in the case wherein twenty-pound paper is used, the weight of a single sheet of paper can be calculated as described above. This will result in an estimated weight per media sheet of 0.01 pounds.

As an alternative to the process of manual entry of the weight of the media “M” into the memory 201, the weight of the media can be entered into the memory automatically. For example, an automatic media weight reading device (not shown), such as a bar-code reader or the like, can also be employed. That is, in the case of paper media “M,” the packaging of each ream of paper media “M” can bear a bar-code or the like which contains data representative of the weight of the media contained in the packaging.

The apparatus 100 can comprise a bar-code reader (not shown) which is connected in signal communication to the controller 110, and which can be employed to automatically read the bar-code on the packaging of each ream of paper media “M.”That is, prior to the unwrapping of the media “M” the package of media can be swept across the bar-code reader to automatically enter the weight of the media into the apparatus 100.

When the bar-code reader reads the bar-code on the packaging of a given ream of paper media “M” the bar-code reader can transmit a signal to the controller 110, wherein the signal contains data representative of the weight of the media, and wherein the signal is ultimately received and entered into the memory 201 where it can be accessed by the processor 215 in accordance with the counting algorithm 209. Thus, in such a manner, the weight of the media “M” can be automatically entered into the memory 201 so as to be available for use in the calculation of the appropriate postage for any given booklet “B.”

Now moving to the step of S206, the apparatus 100 receives an inquiry signal from a client “C” by way of the respective communication link 120C. An inquiry signal can be, for example, a telephone call or a request to open a web page or the like. That is, the organization 112 which is interested in distributing literature through the use of the apparatus 100 can maintain a telephone number and/or a web site, or the like, so as to provide access to the apparatus 100 to clients “C” for the purpose of requesting literature stored in the database 203.

If the organization 112 maintains a telephone number, such as a toll-free telephone number, and if the client interface device 140 is a telephone, then the client “C” can place a telephone call which acts as an inquiry signal and which is received by the controller 110 and acted upon by the signal receiver algorithm 213. The signal receiver algorithm 213 can receive the telephone call placed by the client “C.” The signal receiver algorithm can then alert the prompt algorithm 211 that an inquiry signal has been received. This can be accomplished using, for example, a touch-tone signal input configuration, or a voice recognition input configuration.

If the organization 112 maintains a web site, for example, and if the client interface device 140 is a personal computer having a web browser which is in signal communication with the world wide web (the internet), then the client “C” can access the organization's website to down load the home page of the website. Such downloading of the homepage of the organization's website can act as an inquiry signal which is received by the controller 110 and which is acted upon by the signal receiver algorithm 213. The signal receiver algorithm 213 can alert the prompt algorithm 211 that an inquiry signal has been received.

In accordance with step S208, a name and address signal prompt is sent to the client “C” by way of the respective communication link 120C. For example, if the client interface device is a telephone, then the name and address signal prompt can be an audio signal which asks the client to speak his/her name and address into the telephone. Accordingly, speech-recognition software or the like can be utilized by the signal receiver algorithm 213 to decipher the spoken words of the client “C” and to then route the name and address data of the client to the memory 201, for example, where the name and address is stored in accordance with step S210. In this case, the signal receiver algorithm 213 can include steps to repeat the client's name and address, including the approximated spelling thereof, using voice generation technology.

If the client interface device 140 is a personal computer, for example, the name and address signal prompt can be a web page which is displayed to the client “C.” The web page can be configured to display instructions to the client “C” to enter his/her name and address in the appropriate fields of the web page, wherein the name and address of the client is then transmitted to the controller 110 by way of the respective communication link 120C and received in accordance with the signal receiver algorithm 213. The signal receiver algorithm 213 can then cause the processor 215 to route the name and address of the client “C” to the memory 201, for example, where the name and address is stored in accordance with step S210.

In accordance with step S212, a literature selection prompt signal is sent to the client “C” via the respective communication link 120C. The purpose of the literature selection prompt signal is to determine which literature the client “C” is requesting. For example, if the client interface device 140 is a telephone, the data selection prompt signal can be an audio menu which recites to the client “C” the literature that is available and then asks the client to select the requested literature.

This can be accomplished by instructing the client “C” to push appropriate keys on the keypad of the telephone which correspond to given literature choices which are recited by the audio menu. Alternatively, the client “C” can be instructed to speak his/her literature selection into the telephone, wherein speech-recognition software, or the like, is employed by the signal receiver algorithm 213 to decipher the client's spoken words, and wherein the client's literature selection choices are routed to the literature assembly algorithm 205. In either case, the client's literature selection signal is received by the controller 110 and processed in accordance with the signal receiver algorithm 213 as noted in step S214.

If the client interface device 140 is a personal computer, then the literature selection prompt signal can be in the form of a web page which is displayed to the client “C” on the interface device. The web page can display titles or the like for groups of literature which are available to the client “C.” The client “C” can then make literature selections by selecting offered choices or the like which correspond to specific categories of literature, or by otherwise entering the chosen categories of literature thus requested. The literature choices of the client “C” can then be transmitted to the controller 110 and received by the signal receiver algorithm 213 in accordance with the step S214.

In accordance with the step S216, a finish command prompt signal is sent to the client “C” by way of the communication link 120C and the client interface device 140. The purpose of the finish command prompt signal is to determine if the client “C” has finished choosing literature categories. If the client interface device 140 is a telephone, for example, the finish command prompt signal can be in the form of an audio signal which asks the client “C” if the process of choosing the literature categories has been completed, or if any other information or literature is desired.

If the client “C” wishes to complete the interaction between the client and the apparatus 100, then the client can send a finish command signal to the apparatus by either pushing an appropriate key on the telephone keypad, or by speaking into the telephone in which case the spoken word of the client is received and deciphered by employing speech-recognition technology or the like.

For example, the finish command prompt signal can comprise an audio voice signal that asks, “have you completed your request, and are you ready to end this call? If so, please press one. If not, please press two.” Alternatively, the audio voice signal can ask, “have you completed your request, and are you ready to end this call? If so, please say the word “yes.” If not, please say the word “no.” In this case, a finish command signal would be sent to the apparatus 100 by saying the word “yes.”

If the client interface device 140 is a personal computer, for example, the finish command prompt signal can be a web page with a textual message that reads, “have you completed your request?” In addition, a pair of “boxes” can be presented to the client “C” on the web page, wherein one of the boxes corresponds to the word “yes” and the other box corresponds to the word “no.” The client “C” can then select the box which corresponds to the word “yes” in order to send a command prompt signal to the apparatus 100. Alternatively, the client “C” can select the box which corresponds to the word “no” in order to continue making literature selections, or to otherwise continue to interact with the apparatus 100.

In any case, when the finish command signal is sent via the respective communication link 120C from the client interface device 140 to the apparatus 100 by the client “C,” the signal is received by the controller 110 in accordance with step S218. The finish command signal can be received by the signal receiver algorithm 213 which can, in turn, initiate the retrieval of the literature selections of the client “C” from the memory 201.

In accordance with step S220, the appropriate literature is then retrieved from the database 203 by the processor 215, whereupon the literature selections are transmitted to the booklet-producing device 130, assembled and placed into printing format by the literature assembly algorithm 205, all in accordance with the data selections of the client “C” which have been retrieved from the memory 201.

In accordance with step S222, a customized cover letter can be generated by the cover letter algorithm 207 in response to the receipt of the finish command signal. The cover letter so generated can be based on the name and address of the client “C” as well as the literature selections made by the client during the literature selection process.

That is, the cover letter can contain the client's address and can also contain a salutation which includes the name of the client “C.” For example a cover letter which is to be sent along with a booklet “B” to a client “C” named Jane Doe, who has requested information on products “X,” “Y,” and “Z,” can include the salutation, “Dear Ms. Doe”: The cover letter can continue, for example, with the following sentences: “Thank you for your interest in “X,” “Y,” and “Z.” Please find the literature regarding these products which we have included herewith.”

In accordance with step S224, the booklet-producing device 130 prints the literature on the media “M” in accordance with the assembly format developed by the literature assembly algorithm 205. Also in accordance with step S224, the booklet-producing device 130 prints the cover letter developed by the cover letter algorithm 207. Any of the known methods of printing can be employed in conjunction with the booklet-producing device 130 for printing the booklet “B.” For example, the printing methods so employed by the booklet-producing device 130 can include laser printing, inkjet printing, or the like.

Moving to step S226, the client's name and address is printed by the booklet-producing device 130 on a sheet of media “M” which will act as the cover sheet of the booklet “B.” The cover sheet is the sheet of media “M” which will be the outermost sheet of media when the booklet is completed. The cover sheet can be the same type of media “M” as the remainder of the booklet “B.”

Alternatively, however, the cover sheet can be a type of media that is selected specifically to be a cover sheet. For example, the cover sheet can be a sheet of paper media “M” that is heavier than the sheets of paper media that can make up the remainder of the booklet “B.” Alternatively, the cover sheet can be a sheet of plastic media “M” or the like that provides increased durability to afford protection to the remainder of the booklet “B.”

Moving to step S228, the weight of the completed booklet “B” is calculated by the counter algorithm 209. As discussed above, the counter algorithm 209 calculates the weight of a given completed booklet “B” by tracking, or counting, the total number of sheets of media “M” that are used for producing the given booklet. The number of sheets of media “M” that are used to produce the given booklet “B” are multiplied by the known weight of each of the sheets to calculate the total weight of the completed booklet.

The total weight of the completed booklet “B,” as calculated by the processor 215 in accordance with the counting algorithm 209, can then be compared to current postal rate data which can be stored in the memory 201, for example, to calculate the postage for mailing the given completed booklet. Alternatively, the processor can be configured to access the website of the United States Postal Service by way of the internet, in which case the current postage rates can be retrieved there from.

Now progressing to step S230, the booklet-producing device 130 can fold each of the sheets of media “M” which are included in the booklet “B.” The booklet-producing device 130 can then stitch together the folded sheets of media “M” using the stitching materials “S.” The folded and stitched sheets of media “M” form the completed booklet “B.” Also in accordance with step S230, at least one sealing tab “T” can be applied to the booklet “B” on the edge thereof which is opposite the stitching materials, as shown. The sealing tabs “T” can act to hold the booklet “B” closed for mailing. The sealing tabs “T” can be configured to be easily cut or broken by the client “C” when the booklet “B” is received by the client in the mail.

Moving to step S232, the postage for a given booklet “B” is printed on the cover sheet of the given booklet by the booklet-producing device 130. As discussed above, the postage rate for the given booklet “B” can be calculated by the counting algorithm 209. A postage meter (not shown), or the like, which is specifically configured for metering and printing postage, can be employed in conjunction with the booklet-producing device 130 to print the postage on each booklet “B.”

Preferably, however, the postage can be printed directly on a sheet of media “M” by the imaging device 132. In such a case, wherein the postage for a booklet “B” is printed directly on a sheet of media “M” by the imaging device 132, the postage can be purchased and obtained through known systems which are employed to sell and transmit postage by way of the internet. Such internet-based postage services can be obtained from a number of vendors who are authorized by the United States Postal Service to sell and transmit postage via the internet. Such vendors can be accessed on the internet via websites from which postage can be downloaded.

Also in accordance with step S232, the booklets “B” produced as described above can be sorted and/or bundled for bulk mailing by a sorting device (not shown) and bundling device (not shown), respectively. The booklets “B” can also be placed in a postal container, or the like, for transfer to the United States Postal Service, or other suitable postal carrier.

As is evident, the step S234 marks the end of the flow chart 200. It is understood that the steps of the flow chart 200 can occur in any chronological order, and that at least a portion of the steps can occur substantially simultaneously. That is, obviously some of the steps of the flow chart 200 are interdependent, and therefore some of the steps must occur before others of the steps. For example, the blank media “M” must be loaded into the booklet-producing device 130 before the booklet can be printed thereby.

However, some of the steps of the flow chart 200 are not dependent upon other steps and therefore are optional steps which can occur in alternate chronological order relative to others of the steps. For example, the postage for a given booklet “B” can be calculated before the given booklet is printed because the literature assembly algorithm 205 can determine the number of sheets of media “M” that are required for the production of a given booklet “B” before the given booklet is produced. Alternatively, the postage for a given booklet “B” can be calculated substantially simultaneously with the printing of the given booklet.

It is to be understood that each of the steps discussed herein which are described as being performed by the apparatus 100 can be accomplished automatically. When I say “automatically” I mean that a step can be performed without human action. That is, each of the steps which are described herein as being carried out by the apparatus 100, any component thereof, can be performed entirely by the apparatus, including the respective components thereof, without any human action or intervention. Thus, the apparatus 100 can be configured to function as a fully automatic, stand-alone device which is capable of performing, without human action, the tasks for which it is intended.

Briefly turning back to FIG. 3, it is understood that the database 203 can be maintained by the organization 112 as a “read only” database. When I say “read only” I mean that the database 203 can be a read/write data base that is write-protected. That is, the database 203 can be accessed and read in conjunction with the production of a booklet “B” at the request of a client “C” as described above. However, the content of the database can only be altered, or changed, by writing to the database. Because the database 203 is write-protected, the database can be written thereto only by those cognizant individuals who are so authorized by the organization 112.

In this manner, the content of the database 203 can be protected from any unauthorized change or modification thereto. However, under the action of the cognizant individuals who are authorized to breach the write-protection of the database 203, the database can be modified, changed, updated, or the like, in order to make corrections, updates, or the like to the literature contained in the database.

Furthermore, the apparatus 100 can be remotely located with respect to the authorized cognizant individuals. That is, the cognizant individuals can remotely access the apparatus 100 in order to change and/or modify the database 203. Such remote access to the database 203 by the cognizant individuals can be provided by the respective communication link 120A which can be, for example, a telecommunication network or the like.

The database 203, therefore, can be any form of data storage means that afford selective read/write protection as discussed above. For example, the database 203 can be a compact disk, or a series of compact disks, used with a compact disk reading device (not shown), which is employed in conjunction with the apparatus 100 to provide read-only access to the literature. In this manner, the compact disks can be replaced as needed with updated and/or corrected compact disks. Other means of providing such read-only access with write-protection to the database 203 are known in the art and shall not be discussed further herein.

It is also understood that the client “C” can be a customer who accesses the apparatus 100 by way of the respective communication link 120C from a remote location. For example, the client “C” can be a customer who is located in a state which is different from the state in which the apparatus 100 is located. Alternatively, the client “C” can be a field representative of the organization 112, wherein the field representative also accesses the apparatus 100 from a remote location.

In such a case, the field representative can request a booklet “B” on behalf of a customer, wherein the field representative accesses the apparatus 100, requests the booklet “B” in accordance with the procedures discussed above, receives the booklet in the mail, and then delivers the booklet to the customer in person, or by way of a second mailing in which the field representative includes another cover letter to the customer.

As yet another alternative, client “C” can be an employee of the organization 112 who is located at the headquarters, or other office, of the organization, wherein the apparatus 100 is substantially at the same location as the employee. That is, the employee and the apparatus 100 can be in the same building, or in the same room, wherein the client interface device 140 is a computer, or the like, which is linked to the apparatus 100 by way of a respective communication link 120C that is a local area network or the like. As is evident, a plurality of client interface devices 140 can be included in the apparatus 100 so as to provide access to the apparatus to a plurality of clients “C” in a substantially simultaneous manner.

In accordance with a second embodiment of the present invention, a method of distributing literature is disclosed. The method includes producing a booklet which contains selected literature which is assembled and printed on sheets of media in response to selections made by a client who is interested in obtaining the selected literature.

The client can be prompted to send various signals by way of a communication link, such as a telecommunication network, the internet, or the like. The signals thus sent by the client can contain various data which are used in producing the booklet. The client can also be prompted to send a finish command signal which initiates the production of the booklet. Thus, the booklet is produced in response to the finish command signal which is transmitted over a communication link.

The method comprises counting the number of sheets of media which are used in producing the booklet. The method also includes estimating the weight of each of the sheets of media contained in the booklet. Furthermore, the method includes multiplying the number of sheets of media in the booklet by the estimated, or approximated, weight of each sheet of media to calculate the total weight of the media contained in the booklet. Thus, the postage for the booklet can be determined based on the estimated, or approximated, total weight of the media in the booklet thus calculated by counting the sheets of media and multiplying the counted number of sheets of media by the estimated, or approximated, weight thereof.

Also in accordance with the method, the weight of the binding materials can be estimated and added to the total weight of the media contained in the booklet. This can result in a more accurate total weight of the booklet because both the weight of the media and the weight of the binding materials is included. In addition, if the booklet has a cover sheet of media, the weight of the cover sheet of media can be estimated in accordance with the method. The estimated weight of the cover sheet of media can be added to the weight of the sheets of media contained in the booklet. This can result in a more accurate weight of the booklet, since the weight of the cover sheet of media is accounted for in the total weight of the booklet.

The postage for the booklet can be calculated based on the total weight of the media contained in the booklet as well as the weight of the binding materials included therein. The postage for the booklet can also be calculated based on the total weight of the media contained in the booklet as well as the weight of the cover sheet of media included in the booklet.

In accordance with a third embodiment of the present invention, another method of distributing literature is disclosed. The method includes automatically calculating the weight of a booklet which contains selected portions of the literature, wherein the weight of the booklet is calculated by multiplying the number of sheets of media which are used in the booklet by the estimated, or approximated, weight of each sheet of media.

The method also comprises automatically calculating the postage for the booklet, wherein the postage is calculated based on the weight of the booklet. The method further comprises automatically printing the postage on the booklet. Preferably, the postage is printed on the cover sheet of the booklet. The postage can be printed on the booklet after the booklet has been produced, or in the alternative, the postage can be printed on the booklet during the production of the booklet. The method can also include automatically folding each sheet of media and automatically stitching each sheet of folded media together. Further, at least one sealing tab can be applied to the booklet.

The method, in accordance with the third embodiment of the present invention, can include automatically receiving an inquiry signal from the client by way of a communication link and automatically sending a name and address prompt signal back to the client via the communication link in response to receiving the inquiry signal. The client can then send a name and address data signal back through the communication link which is then received in response to the name and address prompt signal, wherein the name and address signal bears the name and address of the client. The method can include storing the name and address of the client in a memory in response to receiving the name and address data signal.

A literature selection prompt signal can be sent to the client via the communication link in response to receiving the name and address data signal, wherein such a literature selection prompt signal requests that the client select, from various available choices, the literature in which the client is interested. Thus, the client can then send a literature selection data signal via the communication link which is received in response to the literature selection prompt signal, wherein the literature selection data signal bears the literature selections made by the client.

A finish command prompt signal can also be sent to the client in response to receiving the literature selection data signal, wherein such a command prompt signal queries the client to determine if all of the literature selections have been made. A finish command signal can then be received from the client via the communication link in response to the finish command prompt signal. The literature selected by the client can then be assembled into printing format in response to the receipt of the finish command signal from the client. The assembled selected literature can then be printed onto sheets of media in response to assembling the literature selected by the client.

The method can further include retrieving the name and address data from the memory in response to receiving the finish command prompt signal. The step of automatically generating a customized cover letter can be performed in response to receiving the finish command signal, wherein the cover letter is addressed to the client and which is based on literature which has been selected by the client. That is, the cover letter can take into account the literature selected by the client and can address those literature selections.

The cover letter can be printed on a sheet of media which is to be included in the booklet. Thus, the method includes assessing the portions of the literature which the client selects, and producing a booklet containing the selected literature. A cover letter can also be produced which addresses the client's selections, and is included with the booklet. The booklet can be automatically addressed to the client based on the name and address which is provided by the client. The postage is also automatically calculated and printed on the booklet, readying the booklet for mailing to the client.

Although some of the steps of the method in accordance with the third embodiment of the instant invention have been described above as occurring in response to other specified steps, it is understood that any of the steps described herein can alternatively be made to occur in response to any other of the steps wherein the steps are made to occur in a naturally logical sequence. For example, the step of printing a customized cover letter can, in the alternative to that which is described above, be made to occur in response to both receiving the name and address data signal and receiving the literature selection data signal.

As is evident, the distribution of literature in accordance with the apparatus and methods disclosed herein will result in more efficient allocation of resources such as postal capacity, shipping capacity and resources such as media. This more efficient allocation of resources is the result of producing booklets which contain only the literature which the client is interested in receiving and which do not contain redundant literature or any type of redundant information. Furthermore, waste is reduced by printing only the booklets which will ultimately be received by clients.

While the above invention has been described in language more or less specific as to structural and methodical features, it is to be understood, however, that the invention is not limited to the specific features shown and described, since the means herein disclosed comprise preferred forms of putting the invention into effect. The invention is, therefore, claimed in any of its forms or modifications within the proper scope of the appended claims appropriately interpreted in accordance with the doctrine of equivalents.

What is claimed is:

1. A method of distributing literature in the form of a booklet which includes a plurality of sheets of media, comprising:
counting the number of sheets of media in the booklet;
estimating the weight of each sheet of media; and, multiplying the number of sheets of media in the booklet by the estimated weight of each sheet of media to calculate the total weight of the media.

2. The method of claim 1, wherein the booklet includes binding materials to hold the sheets of media together, the method further comprising:
estimating the weight of the binding materials; and,
adding the weight of the binding materials and the total weight of the media.

3. The method of claim 1, wherein the booklet includes a cover, the method further comprising:
estimating the weight of the cover; and,
adding the weight of the cover to the total weight of the media.

4. The method claim 1, further comprising automatically calculating postage for the booklet based on the total weight of the media.

5. The method of claim 2, further comprising automatically calculating postage for the booklet based on the total weight of the media together with the weight of the binding materials.

6. The method of claim 3, further comprising automatically calculating postage for the booklet based on the total weight of the media together with the weight of the cover.

7. A method of distributing literature in the form of a booklet comprised of a plurality of sheets of media collectively defining a weight, the method, comprising:
calculating the weight of the booklet by multiplying the number of sheets of media which are used in the booklet by the estimated weight of each sheet of media;
calculating a postage to be paid to a delivery service to deliver the booklet to an individual, wherein the postage is calculated based on the weight of booklet; and,
printing the postage on the booklet.

8. The method of claim 7, and further comprising:
receiving a client inquiry;
prompting the client for a name and address in response to the client inquiry;
receiving a name and address from the client in response to the prompt; etc.
sending a literature selection prompt signal to the client via the communication link in response to receiving the name and address data signal;
receiving a literature selection data signal from the client via the communication link in response to sending the selection prompt signal;
sending a finish command prompt signal to the client via the communication link in response to receiving the selection data signal;
receiving a command signal from the client via the communication link in response to sending the finish command prompt signal, and wherein the weight of the booklet is calculated in response to receiving the command signal.

9. The method of claim 8, and further comprising:
assembling selected literature in response to the receiving the finish command signal; and,
printing the selected literature onto sheets of media in response to assembling the selected literature.

10. The method of claim 9, and further comprising:
storing a name and address of a client in a memory in response to receiving the name and address data signal;
retrieving the name and address of the client from the memory in response to receiving the finish command signal; and,
printing the name and address of the client on a cover sheet of media in response to retrieving the name and address of the client from the memory.

11. The method of claim 7, and further comprising:
automatically generating a customized cover letter addressed to a client based on literature selected by the client and in response to receiving the finish command signal; and,
printing the cover letter on a sheet of media which is to be included in the booklet in response to generating the customized cover letter.

12. An apparatus for automatically distributing literature to a client, comprising:
a processor;
a database comprising literature;
a controller configured to control various operational aspects of the apparatus;
a booklet-producing device configured to produce a booklet which contains selected portions of the literature;
a communication link which is connectable between the controller and the booklet-producing device, and which is configured to provide signal communication there between; and,
wherein the processor is configured to receive a request for the selected portions of the literature, to retrieve the selected portions of the literature from the database, and to transmit the selected portions of the literature to the booklet producing device via the communication link.

13. The apparatus of claim 12, and further comprising a database which is resident within the controller and which is configured to contain all of the literature from which selected literature can be obtained for printing in the booklet, and wherein the processor is further configured to execute a series of computer executable steps to assemble selected portions of the literature from the database into a printable format to be printed by the booklet-producing device.

14. The apparatus of claim 12, and wherein the processor is configured to execute a series of computer executable steps to generate a cover letter addressed to the client, wherein the cover letter is based on portions of the literature selected by the client.

15. The apparatus of claim 12, and wherein:
the booklet comprises a plurality of sheets of media; and,
the processor is configured to execute a series of computer executable steps to count the number of sheet of media which are used in making a given booklet and to calculate the postage for the given booklet based on the number of sheets of media counted for the given booklet, and on an estimated weight of each sheet of media.

16. The apparatus of claim 12, and wherein the processor is configured to execute a series of computer executable steps to generate prompt signals to send to the client.

17. The apparatus of claim 12, and wherein the processor is configured to execute a series of computer executable steps to receive and direct signals from the client via a communication link.

18. The apparatus of claim 12, and further comprising a client interface device in signal communication with the controller.
